(19) United States
(12) Patent Application Publication
(10) Pub. No.: US 2008/0246902 A1
(43) Pub. Date: Oct. 9, 2008

(54) LCD PANEL

(75) Inventor: Chu-Liang Cheng, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Chu-Liang Cheng, Taipei County (TW)

(21) Appl. No.: 12/099,166

(22) Filed: Apr. 8, 2008

(30) Foreign Application Priority Data
Apr. 9, 2007 (TW) 96112245

(51) Int. Cl. G02F 1/13357

(52) U.S. Cl. 349/69; 349/71

(57) ABSTRACT

A LCD panel is provided. The LCD panel includes a front substrate, a plurality of first phosphor composites, a plurality of second phosphor composites, a black matrix, a transparent electrode, a TFT array substrate and a liquid crystal layer. The liquid crystal layer is sandwiched between the front substrate and the TFT array substrate. The first phosphor composites, the second phosphor composites, the black matrix and the transparent electrode are disposed on the front substrate. The black matrix divides the front substrate into three windows including first windows, second windows and third windows periodically, wherein the first phosphor composites are disposed on the first windows, and the second phosphor composites are disposed on the second windows. The first phosphor composites and the second phosphor composites are capable of converting the primary light shinning towards the LCD panel into different colors respectively.

### CROSS-REFERENCE TO RELATED APPLICATION

This application claims the priority benefit of Taiwan application serial no. 96112245, filed on Apr. 9, 2007. The entirety the above-mentioned patent application is hereby incorporated by reference herein and made a part of specification.

### BACKGROUND OF THE INVENTION

1. Field of the Invention

The present invention is related to a display panel. More particularly, the present invention relates to a liquid crystal display (LCD) panel.

2. Description of Related Art

Liquid crystal display (LCD) device is commonly used in the image presentation daily and uses liquid crystal to control the passage of light. The mainstream of the modern LCD device is thin-film transistor (TFT) LCD device which is driven by the TFTs in the pixel structures to operate.

FIG. 1 is a schematic cross-sectional view of a conventional TFT-LCD device. Referring to FIG. 1, the TFT-LCD device 100 includes a LCD panel 200 and a backlight module 110. The LCD panel 200 includes a TFT array substrate 210, a liquid crystal layer 220, and a color filter array substrate 230, wherein the liquid crystal layer 220 is sandwiched between the color filter array substrate 230 and the TFT array substrate 210.

The color filter array substrate 230 has a substrate 232, a transparent electrode 234, a plurality of color filters 236r, 236g, 236b, and a black matrix 238. The color of the light passing through the color filters 236r, 236g, and 236b are red, green, and blue separately. The substrate 232 is fitted with color filters 236r, 236g and 236b separated by the black matrix 238. The transparent electrode 234 covers the color filters 236r, 236b, 236b and the black matrix 238.

The backlight module 110 provides a white light L1 towards the LCD panel 200, and the white light L1 pass through the TFT array substrate 210 and the color filter array substrate 230 in sequence. The white light L1 may be generated from a cold cathode fluorescent lamp (CCFL) or a white light emitting diode (LED). The TFT array substrate 210 has a plurality of TFTs 212r, 212g, 212b, a plurality of sub-pixel electrodes 214r, 214g, 214b and a substrate 216, and the sub-pixel electrodes 214r, 214g, 214b are fabricated on the substrate 216.

The TFTs 212r and the sub-pixel electrodes 214r are opposite to the color filters 236r. The TFTs 212g and the sub-pixel electrodes 214g are opposite to the color filters 236g. The TFTs 212b and the sub-pixel electrodes 214b are opposite to the color filters 236b. In other words, the color filters 236r correspond to the TFTs 212r and the sub-pixel electrodes 214r. The color filters 236g correspond to the TFTs 212g and the sub-pixel electrodes 214g. The color filters 236b correspond to the TFTs 212b and the sub-pixel electrodes 214b.

When voltage is applied to one of the TFTs, such as TFT 212r, 212g and 212b, the liquid crystal of the liquid crystal layer 220 corresponding to the said TFT is bent, and the white light L1 is allowed to pass through the corresponding sub-pixel electrodes, such as sub-pixel electrodes 214r, 214b, 214g. For example, when voltage is applied to the TFT 212r, the liquid crystal over the TFT 212r is bent, so that the white light L1 is allowed to pass through the sub-pixel electrode 214r.

Three color filters 236r, 236g, 236b, and three sub-pixel electrodes 214r, 214g, 214b are defined a pixel P1 (as shown in FIG. 1). Therefore, each pixel P1 is divided into three color filters 236r, 236b, 236g, and each color filter 236r, 236b, or 236g only allows one of the three colors (red/green/blue for example) of the white light L1 to pass through.

Each sub-pixel electrode, for example sub-pixel electrode 214r, 214g, and 214b, can be controlled independently to yield thousands or millions of possible colors for each pixel P1. Since each color filter, like color filters 236r, 236b, and 236g, only passes through one color component (red/green/blue) of the white light L1, only ⅓ of the white light L1 is utilized. Thus the luminance efficiency of the color filter 236r, 236b, 236g is low, approximately 33% or lower.

### SUMMARY OF THE INVENTION

Accordingly, the present invention is directed to a LCD panel, so as to increase the luminance of the LCD device.

The present invention provides a LCD panel comprising a front substrate, a plurality of first phosphor composites, a plurality of second phosphor composites, a transparent electrode, a black matrix, a TFT array substrate and a liquid crystal layer. The first phosphor composites, the second phosphor composites, the black matrix and the transparent electrode are disposed on the front substrate. The black matrix divides the front substrate into three windows comprising first windows, second windows and third windows periodically. The first phosphor composites are disposed on the first windows, and the second phosphor composites are disposed on the second windows. The TFT array substrate comprises a back substrate, a plurality of TFTs and a plurality of sub-pixel electrodes. The TFTs and the sub-pixel electrodes are disposed on the back substrate, and the sub-pixel electrodes are opposite to the windows defined by the black matrix. The first phosphor composites and the second phosphor composites are capable of converting a primary light shinning towards the LCD panel into different colors respectively. The liquid crystal layer is sandwiched between the front substrate and the TFT array substrate.

The present invention provides a LCD panel comprising a front substrate, a transparent electrode, a black matrix, a TFT array substrate, a liquid crystal layer, a plurality of first phosphor composites, and a plurality of second phosphor composites. The black matrix and the transparent electrode are disposed on the front substrate. The black matrix divides the front substrate into three windows comprising first windows, second windows and third windows periodically. The TFT array substrate comprises a back substrate, a plurality of TFTs and a plurality of sub-pixel electrodes. The TFTs and the sub-pixel electrodes are disposed on the back substrate, and the sub-pixel electrodes are opposite to the windows of the front substrate defined by the black matrix. The liquid crystal layer is sandwiched between the front substrate and the TFT array substrate. The first phosphor composites and the second phosphor composites are placed under the back substrate. The first phosphor composites are opposite to the first windows, and the second phosphor composites are opposite to the second windows. The first phosphor composites and the second phosphor composites are capable of converting a primary light shinning towards the LCD panel into different colors respectively.

Based on the above, the commonly used color filters (CF) for a LCD panel is replaced by a plurality of phosphor composites, such as first phosphor composites and second phosphor composites. These phosphor composites are capable of converting the color of the said primary light into different colors. Since the light utilization rate is much higher, high luminance of the LCD panel can be achieved.

### BRIEF DESCRIPTION OF THE DRAWINGS

The accompanying drawings are included to provide a further understanding of the invention, and are incorporated in and constitute a portion of this specification. The drawings illustrate embodiments of the invention and, together with the description, serve to explain the principles of the invention.

FIG. 1 is a schematic cross-sectional view of a conventional TFT-LCD device.

FIG. 2 is a schematic cross-sectional view of a LCD panel according to a first embodiment of the present invention.

FIG. 3 is a schematic cross-sectional view of a LCD panel according to a second embodiment of the present invention.

FIG. 4 is a schematic cross-sectional view of a LCD panel according to a third embodiment of the present invention.

FIG. 5 is a schematic cross-sectional view of a LCD panel according to a fourth embodiment of the present invention.

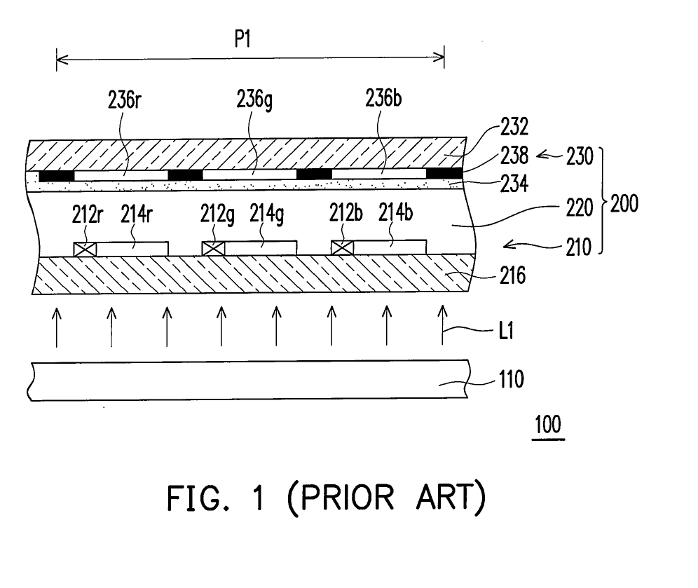

### DESCRIPTION OF EMBODIMENTS

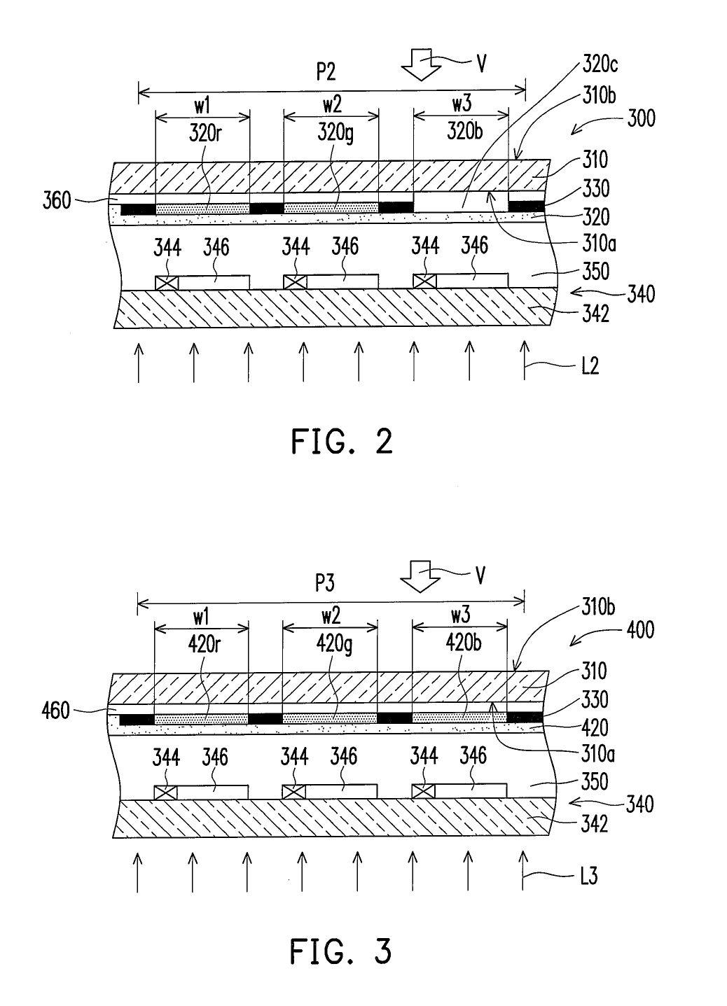

FIG. 2 is a schematic cross-sectional view of a LCD panel according to a first embodiment of the present invention. Referring to FIG. 2, a LCD panel 300 includes a front substrate 310, a plurality of first phosphor composites 320r, a plurality of second phosphor composites 320g, a transparent electrode 320, a black matrix 330, a TFT array substrate 340, and a liquid crystal layer 350, wherein the liquid crystal layer 350 is sandwiched between the front substrate 310 and the TFT array substrate 340.

The first phosphor composites 320r, the second phosphor composites 320g, the black matrix 330 and the transparent electrode 320 are disposed on the front substrate 310. For example, the phosphor composites 320r and 320g, the black matrix 330 and the transparent electrode 320 may be disposed on the surface 310a of the front substrate 310, and the transparent electrode 320 may cover the first phosphor composites 320r, the second phosphor composites 320g, the black matrix 330 and part of the front substrate 310.

The black matrix 330 divides the front substrate 310 into three windows including first windows W1, second windows W2 and third windows W3 periodically. The first phosphor composites 320r are disposed on the first windows W1, and the second phosphor composites 320g are disposed on the second windows W2. A transparent filler 320c may be disposed on the third windows W3 for planarization. It means that the window 320b is transparent.

On the surface 310a of the front substrate 310, the black matrix 330, the first phosphor composites 320r and the second phosphor composites 320g along with the transparent windows 320b are formed at intervals of a pixel P2 and repeated periodically on the front substrate 310.

A primary light L2 shines towards the LCD panel 300. For example, the primary light L2 may be from a backlight module (not shown) which the LCD panel 300 is adapted to installing with, and the primary light L2 may be derived from light emitting diodes (LED), laser diode, or fluorescent lamp. Otherwise, the first phosphor composites 320r and the second phosphor composites 320g are capable of converting the primary light L2 shinning towards the LCD panel 300 into different colors respectively, and the primary light L2 can pass through transparent window 320b.

The phosphor composites, such as the first phosphor composites 320r and the second phosphor composites 320g, can be a mixture of phosphors and fillers. For example, the fillers can be a transparent photo-resist, a gel, an elastomer, a silicone, or an epoxy resin. The phosphors such as SrS:Eu²⁺, or Eu doped silicates for red emission; SrGa₂S₄:Eu²⁺, or Eu doped silicates for green emission can be used.

The primary light L2 may be a blue light with wavelength ranging from 400 nm to 490 nm, which the windows 320b allow to pass through. The first phosphor composites 320r are capable of converting the primary light L2 into a red light, and the second phosphor composites 320g are capable of converting the primary light L2 into a green light. For example, the red light converted has wavelength ranging from 590 nm to 700 nm, and the green light converted has wavelength ranging from 490 nm to 590 nm. Hence, these phosphor composites 320r, 320g and the transparent window 320b realize three sub-pixels of different colors without color filters.

Since the primary light L2 either passes through the transparent window 320b, or is converted into different color lights, like red light or green light, by phosphor composites 320r and 320g with high efficiencies, the primary light L2 is essentially fully utilized, causing high luminance efficiency when compared with conventional color filtering processes. Since three color lights (red, green, and blue light) are either from the light source, for example light emitting diode, or emitted from the phosphor composites 320r and 320g, the spectral purity makes it possible to achieve better color gamut.

The TFT array substrate 340 comprising a back substrate 342, a plurality of TFTs 344 and a plurality of sub-pixel electrodes 346. The TFTs 344 and the sub-pixel electrodes 346 are disposed on the back substrate 342, and the sub-pixel electrodes 346 are opposite to the windows W1, W2 and W3 of the front substrate 310 defined by the black matrix 330. In other words, each of the sub-pixel electrodes 346 is corresponding to one of the phosphor composites 320r, 320g, and one of the transparent windows 320b.

In the embodiment, the LCD panel 300 further includes a filter 360, and the filter 360 is above the phosphor composites 320r, 320g in a viewing direction V of the LCD panel 300, as shown in FIG. 2. For example, the filter 360 may be sandwiched by the first phosphor composites 320r, the second phosphor composites 320g, and the front substrate 310. In another embodiment without drawn, the filter 360 may be on the top surface 310b of the front substrate 310.

The filter 360 can be a primary light blocking filter. The portion of the primary light L2 that is not completely converted into the desired color light can be filtered by the filter 360. Furthermore, the filter 360 can also be a band pass filter or multiple band pass filter. Such filter serves several purposes. The portion of the primary light L2 that is not completely converted into the desired color lights can be filtered by the filter 360, and the spectral widths of the converted lights passing through the filter can also be further narrowed to improve the color purities. It is noted that the transparent window 320b is designed to let the primary light L2 pass through, and there is no filter 360 on the transparent window 320b.

It is emphasized that the filter 360 is a selective component of the embodiment, so that the filter 360 in FIG. 2 is merely used to illustrate, but not intended to limit the present invention.

FIG. 3 is a schematic cross-sectional view of a LCD panel according to a second embodiment of the present invention. Referring to FIG. 3, a LCD panel 400 includes the front substrate 310, a transparent electrode 420, a plurality of first phosphor composites 420r, a plurality of second phosphor composites 420g, a plurality of third phosphor composites 420b, the black matrix 330, the TFT array substrate 340, and the liquid crystal layer 350.

The first phosphor composites 420r, the second phosphor composites 420g, the third phosphor composites 420b, the black matrix 330 and the transparent electrode 420 are disposed on the front substrate 310. For example, the black matrix 330, the phosphor composites 420r, 420g, 420b and the transparent electrode 420 may be disposed on the surface 310a of the front substrate 310, and the transparent electrode 420 may cover the first phosphor composites 420r, the second phosphor composites 420g, the third phosphor composites 420b, and the black matrix 330.

The black matrix 330 divides the front substrate 310 into three windows including first windows W1, second windows W2 and third windows W3 periodically. The first phosphor composites 420r are disposed on the first windows W1, the second phosphor composites 420g are disposed on the second windows W2, and the third phosphor composites 420b are disposed on the third windows W3.

On the surface 310a of the front substrate 310, the black matrix 330 and phosphor composites 420r, 420g and 420b are formed at intervals of a pixel P3, and repeated periodically on the front substrate 310. That is to say, the first phosphor composites 420r, the second phosphor composites 420g and the third phosphor composites 420b are periodically arranged.

A primary light L3 shines towards the LCD panel 400. For example, the primary light L3 may be from a backlight module (not shown) which the LCD panel 400 is adapted to installing with, and the primary light L3 may be derived from light emitting diodes, laser diode, or fluorescent lamp. Otherwise, the first phosphor composites 420r, the second phosphor composites 420g, and the third phosphor composites 420b are capable of converting the primary light L3 shinning towards the LCD panel 400 into different colors respectively.

The phosphor composites, such as the first phosphor composites 420r, the second phosphor composites 420g and the third phosphor composites 420b, can be a mixture of phosphors and fillers. For example, the fillers can be a transparent photo-resist, a gel, an elastomer, a silicone, or an epoxy resin. Phosphors such as SrS:Eu²⁺, or Sr₂Si₅N₈:Eu²⁺, or Gd₂O₂S:Eu³⁺, or Eu doped silicates for red emission; SrGa₂S₄:Eu²⁺, or SrAl₂O₄:Eu²⁺, or Eu doped silicates for green emission; Sr₅(PO₄)Cl:Eu²⁺, or BaMgAl₁₀O₁₇:Eu²⁺ for blue emission can be used.

The primary light L3 may be a light with wavelength ranging from 300 nm to 490 nm. The first phosphor composites 420r are capable of converting the primary light L3 into a red light which has wavelength ranging from 590 nm to 700 nm. The second phosphor composites 420g are capable of converting the primary light L3 into a green light which has wavelength ranging from 490 nm to 590 nm. The third phosphor composite 420b are capable of converting the primary light L3 into a blue light which has wavelength ranging from 400 nm to 490 nm.

These phosphor composites 420r, 420g and 420b realize three sub-pixels of different colors without color filters. Since the primary light L3 is converted into different color lights, like red light, green light or blue light, by phosphor composites 420r, 420g and 420b with high efficiencies, the primary light L3 is essentially fully utilized, causing high luminance efficiency when compared with conventional color filtering processes. Since three color lights (red, green, and blue light) are emitted from these phosphor composites 420r, 420g, and 420b, the spectral purity makes it possible to achieve better color gamut also.

The TFT array substrate 340 comprising a back substrate 342, a plurality of TFTs 344 and a plurality of sub-pixel electrodes 346. The TFTs 344 and the sub-pixel electrodes 346 are disposed on the back substrate 342, and the sub-pixel electrodes 346 are opposite to the windows W1, W2 and W3 of the front substrate 310 defined by the black matrix 330. In other words, each of the sub-pixel electrodes 346 is corresponding to one of the phosphor composites 420r, 420g, and 420b.

In the second embodiment, the LCD panel 400 further includes a filter 460, and the filter 460 is above phosphor composites 420r, 420g and 420b in a viewing direction V of the LCD panel 400, as shown in FIG. 3. For example, the filter 460 may be sandwiched by the first phosphor composites 420r, the second phosphor composites 420g, the third phosphor composites 420b and the front substrate 310. In another embodiment without drawn, the filter 460 may be on the top surface 310b of the front substrate 310.

The filter 460 can be a primary light blocking filter. The portion of the primary light L3 that is not completely converted into the desired color light can be filtered by the filter 460. Furthermore, the filter 460 can also be a band pass filter or multiple band pass filter. Such filter serves several purposes. The portion of the primary light L3 that is not completely converted into the desired color light can be filtered by the filter 460, and the spectral widths of the converted lights passing through the filter can also be further narrowed to improve the color purities.

It is emphasized that the filter 460 is a selective component of the embodiment, so that the filter 460 in FIG. 3 is merely used to illustrate, but not intended to limit the present invention.

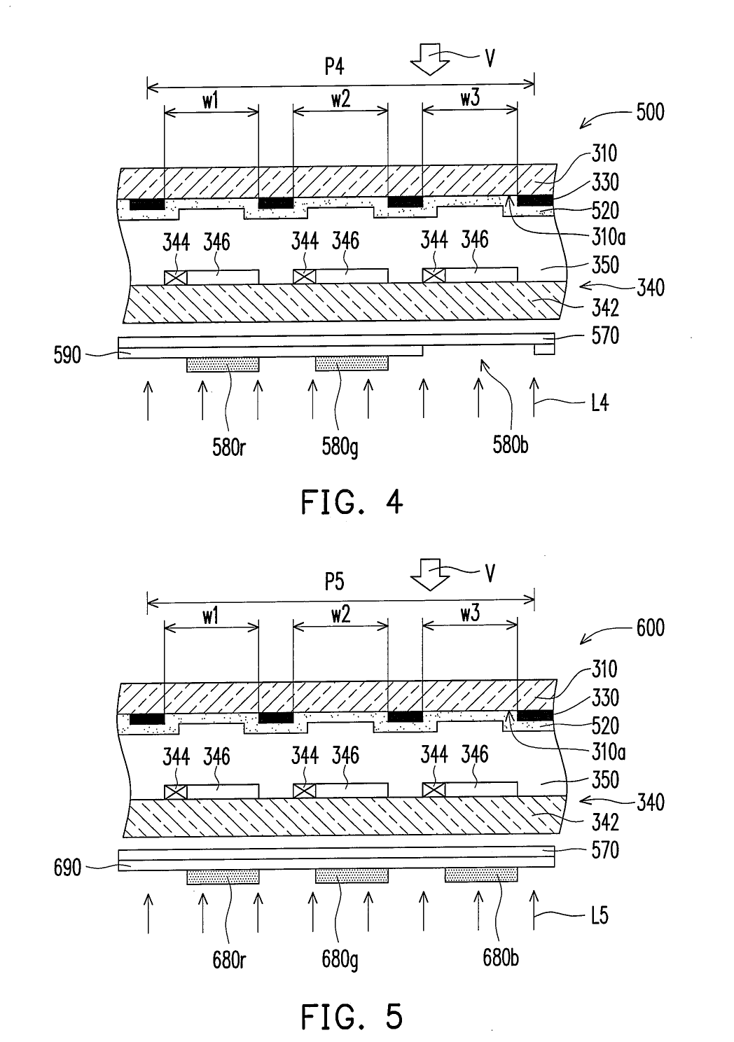

FIG. 4 is a schematic cross-sectional view of a LCD panel according to a third embodiment of the present invention. Referring to FIG. 4, a LCD panel 500 includes the front substrate 310, a transparent electrode 520, the black matrix 330, the TFT array substrate 340, the liquid crystal layer 350, a plurality of first phosphor composites 580r, and a plurality of second phosphor composites 580g.

The black matrix 330 divides the front substrate 310 into three windows including first windows W1, second windows W2 and third windows W3 periodically, wherein the black matrix 330 and the transparent electrode 520 are disposed on the front substrate 310. On the surface 310a of the front substrate 310, the black matrix 330 are formed at intervals of a pixel P4, and repeated periodically on the front substrate 310. The TFT array substrate 340 comprising a back substrate 342, and the TFTs 344 and the sub-pixel electrodes 346 are disposed on the back substrate 342. The sub-pixel electrodes 346 are opposite to the windows W1, W2 and W3 of the front substrate 310 defined by the black matrix 330.

The first phosphor composites 580r are opposite to the first windows W1, and the second phosphor composites 580g are opposite to the second windows W2, wherein the first phosphor composites 580r and the second phosphor composites 580g are placed under the back substrate 342 of the TFT array substrate 340. For example, the LCD panel 500 further includes a transparent substrate 570 disposed under the TFT array substrate 340, wherein the first phosphor composites 580r and the second phosphor composites 580g are disposed on.

In another embodiment without drawn, the first phosphor composites 580r and the second phosphor composites 580g may be disposed on the back of the TFT array substrate 340, and corresponding to the windows W1 and W2. These phosphor composites 580r and 580g along with a clear window 580b are formed at intervals of the pixel P4 and repeated periodically. That is to say, the first phosphor composites 580r and the second phosphor composites 580g are periodically arranged.

The phosphor composites 580r, 580g are capable of converting a primary light L4 shinning towards the LCD panel 500 into different colors respectively. The primary light L4 may be from a backlight module (not shown) which the LCD panel 500 is adapted to installing with, and the primary light L4 may be derived from light emitting diodes, laser diode, or fluorescent lamp.

The primary light L4 may be a blue light, which can pass through the clear window 580b, with wavelength ranging from 400 nm to 490 nm. The phosphor composites 580r are capable of converting the primary light L4 into a red light with wavelength ranging from 590 nm to 700 nm. The second phosphor composites 580g are capable of converting the primary light L4 into a green light with wavelength ranging from 490 nm to 590 nm. Then, these phosphor composites 580r, 580g and the clear window 580b realize three sub-pixels of different colors without color filters.

Since the primary light L4 either passes through the clear window 580b, or is converted into different color lights, like red light or green light, by phosphor composites 580r and 580g with high efficiencies, the primary light L4 is essentially fully utilized, causing high luminance efficiency when compared with conventional color filtering processes. Since three color lights (red, green, and blue light) are either from the light source, for example light emitting diode (LED), or emitted from the phosphor composites 580r and 580g, the spectral purity makes it possible to achieve better color gamut.

One may also notice that, in the first embodiment (referring FIG. 2), the primary light L2 is switched on-off by the liquid crystal of the liquid crystal layer 350 and then converts its color by the phosphor composite 320r and 320g. While in the third embodiment, the primary light L4 converts it color and then is switched on-off by the liquid crystal of the liquid crystal layer 350.

In the third embodiment, the LCD panel 500 further includes a filter 590. The filter 590 is above the phosphor composites 580r and 580g in a viewing direction V of the LCD panel 500. For example, the filter 590 may be between the phosphor composites 580r, 580g and the back substrate 342. In the embodiment as FIG. 4 shown, the filter 590 can be disposed on a transparent substrate 570 which the LCD panel 500 further includes. The filter 590 can also be added on the TFT array substrate 340, or on the front substrate 310. The clear window 580b is designed to let the primary light L4 pass through; there is no filter above.

The filter 590 can be a primary light blocking filter. The portion of the primary light L4 that is not completely converted into the desired color light can be filtered by the filter 590. Furthermore, the filter 590 can also be a band pass filter or multiple band pass filter. Such filter serves several purposes. The portion of the primary light L4 that is not completely converted into the desired color lights can be filtered by the filter 590, and the spectral widths of the converted lights passing through the filter 590 can also be further narrowed to improve the color purities.

It is emphasized that the filter 590 and the transparent substrate 570 are selective components of the embodiment, so that the filter 590 and the transparent substrate 570 in FIG. 4 are merely used to illustrate, but not intended to limit the present invention.

FIG. 5 is a schematic cross-sectional view of a LCD panel according to a fourth embodiment of the present invention. Referring to FIG. 5, the LCD panel 600 includes the front substrate 310, the transparent electrode 520, the black matrix 330, the TFT array substrate 340, the liquid crystal layer 350, and a plurality of first phosphor composites 680r, a plurality of second phosphor composites 680g, a plurality of third phosphor composites 680b.

The black matrix 330 divides the front substrate 310 into three windows including first windows W1, second windows W2 and third windows W3 periodically, wherein the black matrix 330 and the transparent electrode 520 are disposed on the front substrate 310. On the surface 310a of the front substrate 310, the black matrix 330 are formed at intervals of a pixel P5, and repeated periodically on the front substrate 310. The TFT array substrate 340 comprising a back substrate 342, and the TFTs 344 and the sub-pixel electrodes 346 are disposed on the back substrate 342. The sub-pixel electrodes 346 are opposite to the windows W1, W2 and W3 of the front substrate 310 defined by the black matrix 330.

The first phosphor composites 680r are opposite to the first windows W1, the second phosphor composites 680g are opposite to the second windows W2, and the third phosphor composites 680b are opposite to the third windows W3. The first phosphor composites 680r, the second phosphor composites 680g and the third phosphor composites 680b are placed under the back substrate 342 of the TFT array substrate 340. For example, the LCD panel 600 further includes the transparent substrate 570 disposed under the TFT array substrate 340, wherein the first phosphor composites 680r, the second phosphor composites 580g and the third phosphor composites 680b are disposed on.

In another embodiment without drawn, the first phosphor composites 680r, the second phosphor composites 680g and the third phosphor composites 680b may be disposed on the back of the TFT array substrate 340, and corresponding to the windows W1, W2 and W3. These phosphor composites 680r, 680g and 680b are formed at intervals of a pixel P5, and repeated periodically. That is to say, the first phosphor composites 680r, the second phosphor composites 680g and the third phosphor composites 680b are periodically arranged.

The phosphor composites 680r, 680g and 680b are capable of converting a primary light L5 shinning towards the LCD panel 600 into different colors respectively. The primary light L5 may be from a backlight module (not shown) which the LCD panel 600 is adapted to installing with, and the primary light L5 may be derived from light emitting diodes, laser diode, or fluorescent lamp.

The primary light L5 may be a light with wavelength ranging from 300 nm to 490 nm. The phosphor composites 680r are capable of converting the primary light L5 into a red light with wavelength ranging from 590 nm to 700 nm. The phosphor composites 680g are capable of converting the primary light into a green light with wavelength ranging from 490 nm to 590 nm. The phosphor composites 680b are capable of converting the primary light into a blue light with wavelength ranging from 400 nm to 490 nm. Then, these phosphor composites 680r, 680g and 680b realize three sub-pixels of different colors without color filters.

Since the primary light L5 is converted into different color lights, like red light or green light or blue light, by phosphor composites 680r, 680g and 680b with high efficiencies, the primary light L5 is essentially fully utilized, causing high luminance efficiency when compared with conventional color filtering processes. Since three color lights (red, green, and blue light) are emitted from the phosphor composites 680r, 680g and 680b, the spectral purity makes it possible to achieve better color gamut.

In the fourth embodiment, the LCD panel 600 further includes a filter 690. The filter 690 is disposed above the phosphor composites 680r and 680g and 680b in a viewing direction V of the LCD panel 600. For example, the filter 690 may be between the phosphor composites 680r, 680g, 680b and the back substrate 342. In the embodiment as FIG. 5 shown, the filter 690 can be disposed on the transparent substrate 570 which the LCD panel 600 further includes. The filter 690 can also be added on the TFT array substrate 340, or on the front substrate 310.

The filter 690 can be a primary light blocking filter. The portion of the primary light L5 that is not completely converted into the desired color light can be filtered by the filter 690. Furthermore, the filter 690 can also be a band pass filter or multiple band pass filter. Such filter selves several purposes. The portion of the primary light L5 that is not completely converted into the desired color light can be filtered by the filter 690, and the spectral widths of the converted lights passing through the filter 690 can also be further narrowed to improve the color purities.

It is emphasized that the filter 690 and the transparent substrate 570 are selective components of the embodiment, so that the filter 690 and the transparent substrate 570 in FIG. 5 are merely used to illustrate, but not intended to limit the present invention.

Based on the above, the LCD panel according to the present invention has phosphor composites which are capable of changing the primary light into different color lights for full color display. The conventional color filter can thus be removed, and the LCD panel has higher luminance, better color gamut and lower cost.

In other words, the commonly used color filters for a LCD panel is replaced by a plurality of phosphor composites, such as first phosphor composites, second phosphor composites and third phosphor composites, and the sub-pixel color light is obtained by converting, rather than filtering, and the light utilization rate is much higher.

Otherwise, by properly choosing the phosphor composites and the corresponding primary light, higher luminance can be achieved. Such high luminance efficiency is only limited by the conversion efficiency of phosphor composites used. Furthermore, the spectrum of the converted light is pure and distinct, rendering a higher color gamut.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A LCD panel, comprising:
a front substrate;
a plurality of first phosphor composites;
a plurality of second phosphor composites, wherein the first phosphor composites and the second phosphor composites are capable of converting a primary light shinning towards the LCD panel into different colors respectively;
a transparent electrode;
a black matrix, dividing the front substrate into three windows comprising first windows, second windows and third windows periodically, wherein the first phosphor composites are disposed on the first windows, and the second phosphor composites are disposed on the second windows, wherein the first phosphor composites, the second phosphor composites, the black matrix and the transparent electrode are disposed on the front substrate;
a TFT array substrate, comprising a back substrate, a plurality of TFTs and a plurality of sub-pixel electrodes, wherein the TFTs and the sub-pixel electrodes are disposed on the back substrate, and the sub-pixel electrodes are opposite to the windows; and
a liquid crystal layer, sandwiched between the front substrate and the TFT array substrate.

2. The LCD panel of claim 1, wherein the wavelength of the primary light is ranging from 400 nm to 490 nm, the first phosphor composites are capable of converting the primary light into a light with wavelength ranging from 590 nm to 700 nm, and the second phosphor composites are capable of converting the primary light into a light with wavelength ranging from 490 nm to 590 nm.

3. The LCD panel of claim 1, wherein the primary light is derived from light emitting diodes, or laser diode, or fluorescent lamp.

4. The LCD panel of claim 1, further comprising a plurality of third phosphor composites, wherein the third phosphor composites are disposed on the third windows.

5. The LCD panel of claim 4, wherein the wavelength of the primary light is ranging from 300 nm to 490 nm, the first phosphor composites are capable of converting the primary light into a light with wavelength ranging from 590 nm to 700 nm, the second phosphor composites are capable of converting the primary light into a light with wavelength ranging from 490 nm to 590 nm, and the third phosphor composites are capable of converting the primary light into a light with wavelength ranging from 400 nm to 490 nm.

6. The LCD panel of claim 1, further comprising a filter, wherein the filter is above the phosphor composites in a viewing direction of the LCD panel.

7. The LCD panel of claim 6, wherein the filter is sandwiched between the phosphor composites and the front substrate.

8. The LCD panel of claim 6, wherein the filter is a primary light blocking filter.

9. The LCD panel of claim 6, wherein the filter is a band pass filter or multiple band pass filter through which the spectral widths of the converted lights by the phosphor composites can be reduced.

10. A LCD panel, comprising:
a front substrate;
a transparent electrode;
a black matrix, dividing the front substrate into three windows comprising first windows, second windows and third windows periodically, wherein the black matrix and the transparent electrode are disposed on the front substrate;
a TFT array substrate, comprising a back substrate, a plurality of TFTs and a plurality of sub-pixel electrodes, wherein the TFTs and the sub-pixel electrodes are disposed on the back substrate, and the sub-pixel electrodes are opposite to the windows of the front substrate defined by the black matrix;
a liquid crystal layer, sandwiched between the front substrate and the TFT array substrate;
a plurality of first phosphor composites; and
a plurality of second phosphor composites, wherein the first phosphor composites are opposite to the first windows, and the second phosphor composites are opposite to the second windows, wherein the first phosphor composites and the second phosphor composites are placed under the back substrate, and the first phosphor composites and the second phosphor composites are capable of converting a primary light into different colors respectively.

11. The LCD panel of claim 10, wherein the first phosphor composites and the second phosphor composites are disposed on the back substrate.

12. The LCD panel of claim 10, further comprising a transparent substrate disposed under the TFT array substrate, wherein the first phosphor composites and the second phosphor composites are disposed on.

13. The LCD panel of claim 10, wherein the wavelength of the primary light is ranging from 400 nm to 490 nm, the first phosphor composites are capable of converting the primary light into a light with wavelength ranging from 590 nm to 700 nm, and the second phosphor composites are capable of converting the primary light into a light with wavelength ranging from 490 nm to 590 nm.

14. The LCD panel of claim 10, wherein the primary light is derived from light emitting diodes, or laser diode, or fluorescent lamp.

15. The LCD panel of claim 10, further comprising a plurality of third phosphor composites, wherein the third phosphor composites are opposite to the third windows, wherein the first phosphor composites and the second phosphor composites and the third phosphor composites are placed under the back substrate, and the first phosphor composites and the second phosphor composites and the third phosphor composites are capable of converting the primary light into different colors respectively.

16. The LCD panel of claim 15, wherein the first phosphor composites and the second phosphor composites and the third phosphor composites are disposed on the back substrate.

17. The LCD panel of claim 15, further comprising a transparent substrate disposed under the TFT array substrate, wherein the first phosphor composites and the second phosphor composites and the third phosphor composites are disposed on.

18. The LCD panel of claim 15, wherein the wavelength of the primary light is ranging from 300 nm to 490 nm, the first phosphor composites are capable of converting the primary light into a light with wavelength ranging from 590 nm to 700 nm, the second phosphor composites are capable of converting the primary light into a light with wavelength ranging from 490 nm to 590 nm, and the third phosphor composites are capable of converting the primary light into a light with wavelength ranging from 400 nm to 490 nm.

19. The LCD panel of claim 10, further comprising a filter, wherein the filter is above the phosphor composites in a viewing direction of the LCD panel.

20. The LCD panel of claim 19, wherein the filter is between the phosphor composites and the back substrate.

21. The LCD panel of claim 19, wherein the filter is disposed on a transparent substrate.

22. The LCD panel of claim 19, wherein the filter is a primary light blocking filter.

23. The LCD panel of claim 19, wherein the filter is a band pass filter or multiple band pass filter through which the spectral widths of the converted lights by the phosphor composites can be reduced.
